(19) United States
(12) Patent Application Publication
(10) Pub. No.: US 2010/0144472 A1
(43) Pub. Date: Jun. 10, 2010

(54) CONSTRUCTION COMPRISING A BEARING MOUNTED ON A PLASTIC BODY

(76) Inventors: Harold H.J.P.G. Van Aken, Hoensbroek (NL); Tim W.J.L. Dassen, Schinnen (NL)

Correspondence Address: NIXON & VANDERHYE, PC, 901 NORTH GLEBE ROAD, 11TH FLOOR, ARLINGTON, VA, 22203, US

(21) Appl. No.: 12/524,759

(22) PCT Filed: Jan. 30, 2008
(86) PCT No.: PCT/EP2008/000707

§ 371 Date: Feb. 20, 2010

(30) Foreign Application Priority Data
Jan. 30, 2007 (EP) 07001964.1

(51) Int. Cl. F16H 7/08; F16C 35/02

(52) U.S. Cl. 474/101; 384/428

(57) ABSTRACT

The invention relates to a construction comprising (a) a plastic body comprising a mounting surface and (b) a bearing comprising a rotatable member and an inner member comprising a mounting bore mounted on the plastic body, wherein the plastic body comprises an axial extension comprising an axial extension head and protruding from the mounting surface, the axial extension protrudes into the mounting bore, and the construction comprises a plastic element being fixed to the axial extension head thereby keeping the bearing mounted on the plastic body.

The invention relates to a construction comprising a plastic body and a bearing mounted on the plastic body, more particular a construction comprising a plastic body comprising a mounting surface and a bearing comprising a rotatable member and an inner member comprising a mounting bore mounted on said plastic body.

Such a construction is known from WO2006/105656-A1. The known construction is an assembly of a tensioner which comprises several components including a spring, a tensioner arm comprising a pivot shaft and a rotatable member, such as pulley with either an integral bearing or a separate bearing. The tensioner arm is made of plastic and constitutes a plastic body on which the pulley is mounted. The pulley comprises a bearing with mounting hole and is mounted with the use of a self tapping bolt and a washer. After mounting of the bearing, a dust cap is put in position to protect the bearing. The plastic tensioner arm in the known construction has been designed to replace a metal tensioner arm, as known from the prior art.

Mounting of a bearing on a frame is intended to fix the bearing in such a way as to limit or totally prevent movement of the bearing glider ring in axial, tangential and/or radial direction. Conventionally, the frame, as well as the axle used for the fixation of the bearing is made of metal. The axle can have the form of a extending pin on the frame, or the axle can be a bolt, to be inserted through the bearing and fixed in the frame. Fixation of a bearing on a plastic frame is more complicated then fixation of a bearing on a metal frame, due to the nature of the plastic and its tendency for creep and stress relation. This requires that the self tapping bolt has to be firmly fixed to the plastic tensioner arm.

A problem with the construction comprising the plastic tensioner arm and the bearing mounted thereon with the self tapping bolt is not sustainable enough, in particular due to level of and variation in the mechanical forces applied on the chain tensioner during practical use, resulting in pulling and bending forces upon the bearing and the self tapping bolt, which may result in the plastic part to fail by wear.

Another problem is related to the force needed to fix the self tapping bolt to the plastic tensioner arm. It is very difficult to mount the bearing on the plastic body with the proper force, in order not to apply too little force and not to apply too much force. Too low a force would allow slipping and sliding of the bearing glider ring underneath the washer. This can cause wear of the parts and ultimately failure of the construction. Therefore a high tension in axial direction is needed, not so much for preventing movement of the bearing glider ring in axial direction, but in particular for preventing movement in tangential direction, i.e. bending in- and outwards relative to the axial direction, and in radial direction, i.e. rotating relative to the axial direction, as occurs during slipping and sliding of the bearing glider ring underneath the washer. However, applying a high axial tension results in creep en stress relaxation, which can induce early failure of the construction by loosening of the parts.

Although bending of the self tapping bolt itself might be reduced by using a thicker bolt, this requires a bigger hole into the plastic body for mounting the bolt thereby increasing the risk of damaging the plastic body and the risk of the bolt being pulled out of that hole.

The aim of the invention is provide a construction comprising a plastic body and a bearing mounted on the plastic body or frame wherein these above problems are reduced.

This aim has been achieved with the construction according to the invention, wherein the plastic body comprises an axial extension (eg. a shaft) comprising an axial extension head and protruding from the mounting surface, the axial extension protrudes into the mounting bore, and the construction comprises a plastic element being fixed to the axial extension head thereby keeping the bearing mounted on the plastic body.

The effect of the measures of an axial extension protruding from the mounting surface and protruding into the mounting bore, and a plastic element being fixed to the axial extension head thereby keeping the bearing mounted on the plastic body in the construction according to the invention is that the construction can be made with reduced axial stress and tension applied on the bearing and the plastic body or frame, while still preventing radial and/or tangential movement of the inner member of the bearing. A further advantage is that the mounting elements are made of plastics thereby saving weight and enhancing durability without the use of measures such as anti-rust treatments of the bolt being needed.

### BRIEF DESCRIPTION OF THE FIGURES:

FIG. 1 is an exploded schematic diagram of a construction in accordance with the present invention.

FIG. 2 is an exploded schematic diagram of another construction in accordance with the present invention.

FIG. 3 is a schematic diagram of an axial extension and a plastic element (mounting surface not shown) fixed to the axial extension through being screwed into an opening of the axial extension.

FIG. 4 is a schematic diagram of another axial extension (mounting surface not shown), in which the plastic element is integrally formed onto an end of the axial extension.

### DETAILED DESCRIPTION

The construction according to the invention can be accomplished by different embodiments which are further described below. Several of these embodiments allow further integration of parts and functions thereof, thereby reducing the number of parts needed for the construction.

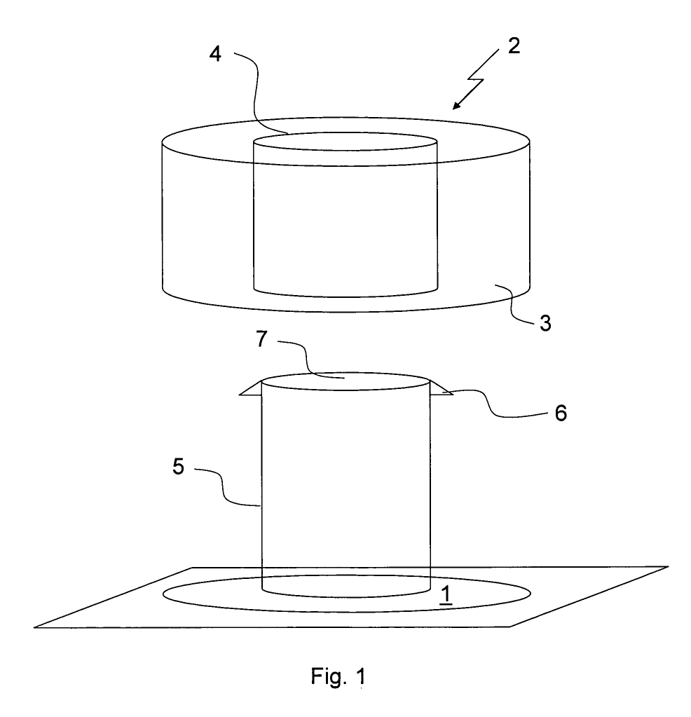

As illustrated in FIG. 1, the construction comprises a plastic body comprising a mounting surface 1 and a bearing 2 comprising a rotatable member 3, (typically in the form of an outer ring) and an inner member (eg. inner ring) which defines a mounting bore 4 from which to receive a plastic axial extension 5, typically in the form of a shaft or axle.

A bearing, as defined in the present invention, is a device to permit constrained relative motion between two parts, such as the rotation movement of the outer ring relative to the inner ring. The bearing encompasses rolling bearings, such as ball, roller or needle bearings. Preferably, the inner member and plastic body are stationary.

Typically, the mounting surface and the shaft or axle are disposed perpendicularly to each other. Preferably, the mounting surface forms part of another functional component, (e.g. tensioning arm) such that the axial extension or shaft serves to connect separate operational components together.

Preferably, the plastic shaft 5 slidingly extends into the mounting bore 4 forming a firm connection, such that no radial movement between the shaft and mounting bore is experienced. Plastic elements 6, in the form of snap fit connections, connect the plastic body to the bearing, mechanically connecting and securing the plastic body to the bearing. Advantageously, the mechanical connection between the plastic body and the bearing prevents movement (axial, tangential and radial) of the bearing around the shaft, thereby directing rotational movement of the bearing to the outer rotatable ring 3.

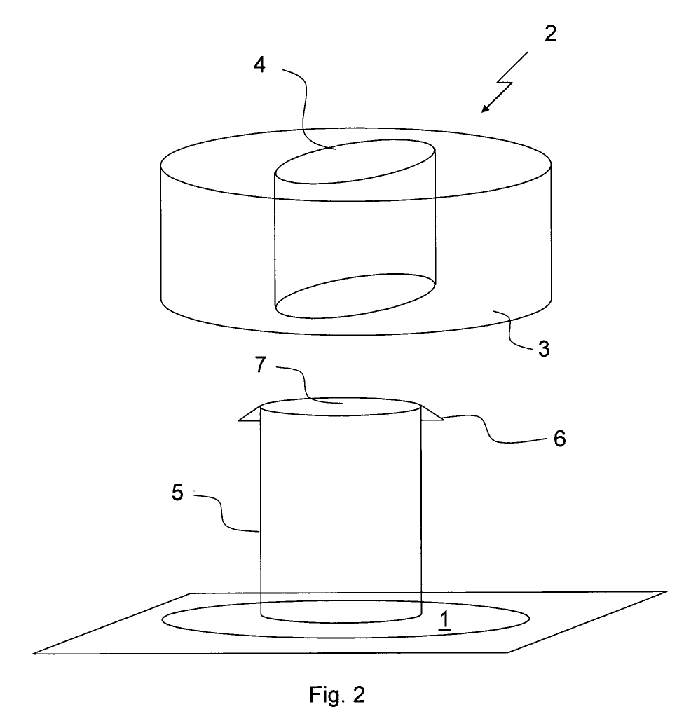

To further prevent movement about the axial extension or shaft, and thus minimize the risk of structural failure, the mounting bore has a non-circular cross section, as illustrated in FIG. 2, with the shaft having a complementary non-circular cross section such that the shaft and mounting bore are in sliding communication. In alternative embodiments, the mounting bore has a square, hexagonal or other polygol cross sectional dimension to complement the opposing cross sectional dimension of the shaft, thereby ensuring that the plastic body and the bearing are tightly fixed to each other and can be taken apart only after applying a substantial axial force.

In this aspect of the invention, the plastic element is preferably a lining of the inner bearing ring or member, which typically transforms the mounting bore from a circular to non-circular cross section. The inner lining is preferably over-moulded onto the inner bearing member or ring, thereby reducing processing steps and components, thus reducing manufacturing costs.

Preferably, the shaft and the mounting bore are in sliding communication along the substantial length of the mounting bore (and preferably through the mounting bore) thereby forming a more robust and secure connection. In embodiments, in which the shaft (axial extension) extends through the mounting bore, the plastic elements preferably form a mechanical connection against the peripheral rim defining the mounting bore (FIGS. 1 & 2). This embodiment provides a construction which is economically and readily assembled and for which the plastic elements may be readily accessible for attachment to the axial extension.

Generally, but not necessarily, the mounting bore 4 of the bearing 2 has two open ends. In one embodiment of the invention, the plastic body 1 is positioned at one end of the mounting bore 4 and the plastic element is a secondary plastic element 6 positioned at or near the other end of the mounting bore. The secondary plastic element 6 is fixed to the axial extension head 7 such that it keeps the bearing mounted on the plastic body. For that purpose the secondary plastic element suitably has a tapered shaped (FIG. 1) or a rim element having a largest diameter being larger than the inner diameter of the mounting bore (FIG. 4). Thus, the plastic element prevents sliding of the bearing from the axial extension.

In another embedment the bearing comprises a mounting bore or hole with an inner lining consisting of plastic, and the plastic element to which the axial extension head is fixed thereby keeping the bearing mounted on the plastic body is the inner lining of the mounting hole. In this aspect of the invention, the inner lining and the axial extension are preferably connected by an adhesive or bonding agent. The use of an adhesive or bonding agent enables a large surface connecting area between the plastic body and the plastic lining, thus providing a robust connection. The combination of the use over-moulding to secure the plastic element to the inner member, combined with the use of an adhesive or bonding agent, enables an almost integral connection to be made between the plastic body and the bearing which is less prone to vibration which may lead to structural failure of the connection. Similarly, similarly beneficial effects may be experienced when the inner lining and shaft comprise complimentary male and female inter-locking mechanisms, such as a screw mechanism.

In the construction according to the invention the plastic element may be fixed to the axial extension head by any method that is suitable for fixing two plastic parts to each other and by which fixing the mounted bearing can be kept on the plastic body.

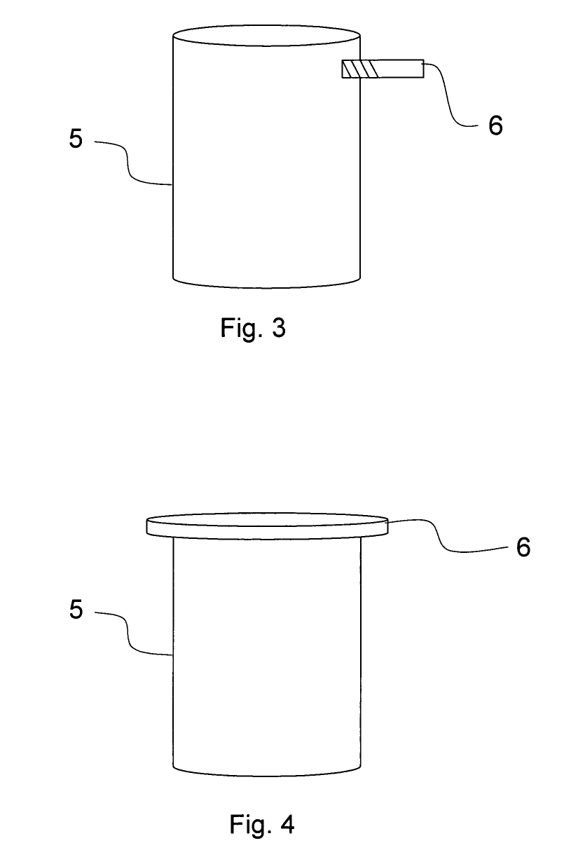

Suitably, the fixing is achieved by mechanical means, such as screwing (FIG. 3), clamping, and snapping (FIG. 1), or physical bonds, such as welding and adhering, as well as combinations thereof. The combination of the plastic element serving as a physical barrier to movement and the slidingly connecting configuration of the axial extension or shaft with the inner mounting bore enables axial and tangential and/or radial movement to be minimised and preferably prevented, thus minimizing the risk of mechanical failure of the connection.

For fixing the plastic element to the axial extension head by screwing, the plastic element and the axial extension head are suitably provided with a male and a female screwing thread.

For fixing the plastic element to the axial extension head by clamping, the plastic element and the axial extension head are suitably provided with a female element comprising a bore having in inner diameter and a male element having an outer diameter to be received by the bore, the female element and the male element have a complementary shape with the inner diameter and outer diameter being essentially equal. This embodiment with the female element and the male element having a complementary shape and the inner diameter and outer diameter being essentially equal ensures that the plastic element to the axial extension are tightly fixed to each other and can be taken apart only after applying a substantial axial force. Suitably, the female element consists of the inner lining of the mounting hole.

For fixing the plastic element to the axial extension head by snapping, the plastic element or the axial extension suitably is provided with one or more snapping element, such as a cantilever snap fit, and the other part of the plastic element or the axial extension is provided with an complementary element to receive the snapping element. Suitably, the complementary element is the mounting bore comprised by the bearing and the axial extension comprises one or more snapping elements, extending though the mounting bore. The use of a snap fit type connection has the advantage of providing a system in which the bearing is easily attachable to the plastic body due to the resilience and flexibility of the snap lock connection, yet the configuration and the plastic connection provides sufficient rigidity to prevent the bearing from being de-attached from the plastic body. Typically, the snap lock would need to fail (i.e. break) before the bearing could be detached from the axial extension or shaft stemming from the plastic frame or body.

For fixing the plastic element to the axial extension head by welding, any method that is suitable for welding two plastic parts may be applied. Suitably, the two parts are welded by vibration welding or radiation welding. Radiation welding can suitably be applied in combination with a plastic element made of a plastic material which transparent, or largely so, for the radiation used for the welding and a plastic body made of a plastic material which absorbs, or largely so, the radiation used for the welding.

For fixing the plastic element to the axial extension head by adhesion, any adhesive that is suitable for adhering two plastic parts may be applied.

The plastic element is being fixed to the axial extension head by an interface area comprising welded parts, screw threads, and/or an adhesive.

The construction comprising the plastic element being fixed to the axial extension head by screwing, welding or adhering can be recognized from an interface surface area between the plastic element and the axial extension comprising screw threads, welded parts, and an adhesive, respectively.

The various methods of fixing may also be combined.

In another embodiment the plastic element and the axial extension constitute a unitary body. Such a unitary body can be made by injection moulding the plastic body comprising the axial extension and the plastic element as an integral part onto the bearing. The advantage of this embodiment is that this provides a higher bonding strength between the axial extension and the plastic element.

The axial extension on the plastic part and the mounting bore in the bearing comprised by the construction according to the invention may have any suitable shape. Preferably, the mounting bore and the axial extension have a corresponding shape. For example, both the axial extension and the mounting bore have a conical shape or a cylindrical shape with a similar circular cross-section.

Preferably, the axial extension has a shape with a non-circular cross-section and the mounting bore has an opening with a corresponding non-circular shape. Suitably, the non-circular cross-section is a polygon, for example a triangle, a quadrangle, a pentagon, or a hexagon. The advantage of the cross-section being non-circular, and in particular a polygon, is that the bearing glider ring is better prevented from movement in radial direction.

The axial extension may suitably comprise a metal insert to strengthen the axis. Preferably the metal insert is overmoulded by the plastic part.

In a preferred embodiment of the invention, the plastic element comprises an integrated dust shield. This has the advantage that even fewer parts have to be assembled.

The rotatable member comprised by the bearing in the construction according to the invention suitably is a pulley or a gear. The pulley may be, for example, a smooth pulley that can be used in combination with a smooth belt or rope, or a toothed pulley, that can be used with a toothed belt. The gear is suitably be combined with a chain.

The construction according to the invention may be any construction suitable for being supported on the rotatable member, for example a wheeled carriage, or suitable for carrying a flexible transport means, for example a pulley for a rope or an tensioner for endless flexible drive means.

Preferably, the construction is a tensioner for endless flexible drive means. Examples of such a tensioner are tensioners used for accessory drive belts or chains on internal combustion engines for vehicles.

The plastic body and the plastic element may consist of the same plastic material or of different plastic materials. Suitably the plastic body, as well as the plastic element, is made of an engineering plastic. While, the plastic element may have some resilience, such that it may effectively function as part of a snap fit type connection, the plastic has preferably sufficient rigidity to prevent removal of the plastic element from the mounting bore in at least one axial direction. As the engineering plastic any suitable engineering plastic may be used. The plastic is preferably selected for strength, resistance to creep and longevity. As is understood by those of skill in the art, engineering plastic includes polyetheretherketone resin (PEEK), polyamideimide resin (PAI), polysulfone resin, polyetherimide resins (PEI), polyimide resins, poly(phenylene sulfide) resins, polyester resins, such as polyethylene terephthalate, bisphenol-A polycarbonate resins, polyester carbonate copolymers, acetal resins, and polyamide or nylon resins. Additionally other materials could be employed, including engineering resin blends or engineering resin alloys, which are mixtures of engineering resins or mixtures of engineering resins with commodity resins, namely poly(phenylene ether)-styrene resin alloys. Examples of engineering resin with engineering resins include: poly(butylene terephthalate)-poly(ethylene terephthalate), polycarbonate-poly(butylene terephthalate), polycarbonate-poly(ethylene terephthalate), polycarbonate-polyester carbonate, polysulfone-poly(ethylene terephthalate), polyarylate-nylon, and poly(phenylene oxide)-nylon. Examples of engineering resins with other resins include: polysulfone-ABS, modified acetal, modified nylon, modified poly(butylene terephthalate), polycarbonate-ABS, polycarbonate-styrene maleic anhydride, and poly(phenylene oxide)-polystyrene.

Examples of suitable plastics include semi-crystalline plastics such as Nylon 6, Nylon 66, Nylon 4/6, polyphtalamide, polyamid and polyimid compounds, polyphenylene sulfide or polyethelene terephtalate.

Preferably, the plastic material is a reinforced material, such as glass fiber reinforced polyamide plastic. Also, materials other than glass, such as aramid fibres or nanoparticles, can be employed to reinforce the selected plastic.

1. Construction comprising (a) a plastic body comprising a mounting surface and (b) a bearing comprising a rotatable member and an inner member comprising a mounting bore mounted on the plastic body, characterized in that
the plastic body comprises an axial extension comprising an axial extension head protruding from the mounting surface,
the axial extension protrudes into the mounting bore, and
the construction comprises a plastic element being fixed to the axial extension head thereby keeping the bearing mounted on the plastic body.

2. Construction according to claim 1, wherein the plastic element is an inner lining of the mounting bore.

3. Construction according to claim 1, wherein the mounting bore has two open ends, the plastic body is positioned at one open end of the mounting bore and the plastic element is a secondary plastic element positioned at or near the other open end of the mounting bore.

4. Construction according to claim 1, wherein the plastic element comprises an integrally moulded dust shield.

5. Construction according to claim 1, wherein the axial extension has a shape with a non-circular cross-section and the mounting bore has an opening with a corresponding non-circular cross-section.

6. Construction according to claim 1, wherein the axial extension comprises a metal insert.

7. Construction according to claim 1, wherein the plastic element is being fixed to the axial extension head by an interface area comprising welded parts, screw threads, and/or an adhesive.

8. Construction according to claim 1, wherein the plastic element is integrally moulded with the plastic body.

9. Construction according to claim 1, wherein the axial extension is a shaft or axle and the plastic element forms a connection between the plastic body and the bearing, thereby preventing axial and tangential and/or radial movement between the plastic body and the bearing.

10. Construction according to claim 1, wherein the axial extension slidingly connects with the mounting bore.

11. Construction according to claim 1, wherein the axial extension slidingly connects along the length of the mounting bore.

12. Use of the construction according to claim 1, as a tensioner for an endless drive means.
